(19) United States
(12) Patent Application Publication
(10) Pub. No.: US 2011/0135152 A1
(43) Pub. Date: Jun. 9, 2011

(54) INFORMATION PROCESSING APPARATUS, INFORMATION PROCESSING METHOD, AND PROGRAM

(76) Inventor: Akifumi KASHIWAGI, Tokyo (JP)

(21) Appl. No.: 12/952,679

(22) Filed: Nov. 23, 2010

(30) Foreign Application Priority Data
Dec. 8, 2009 (JP) P2009-278180

(51) Int. Cl. G06K 9/00

(52) U.S. Cl. 382/103; 382/116

(57) ABSTRACT

An information processing apparatus includes: a detection unit detecting the faces of persons from frames of moving-image contents; a first specifying unit specifying the persons corresponding to the detected faces by extracting feature amounts of the detected faces and verifying the extracted feature amounts in a first database in which the feature amounts of the faces are registered in correspondence with person identifying information; a voice analysis unit analyzing the voices acquired when the faces of the persons are detected from the frames of the moving-image contents and generating voice information; and a second specifying unit specifying the persons corresponding to the detected faces by verifying the voice information corresponding to the face of a person which is not specified by the first specifying unit in a second database in which the voice information is registered in correspondence with the person identifying information.

### BACKGROUND OF THE INVENTION

1. Field of the Invention

The present invention relates to an information processing apparatus, an information processing method, and a program, and more particularly, to an information processing apparatus, an information processing method, and a program capable of detecting the face of a person from an image of moving-image contents with a voice and identifying and tracking the face.

2. Description of the Related Art

In the past, there were suggested numerous methods of detecting and tracking a moving body, such as a person, existing on a moving image. For example, in Japanese Unexamined Patent Application Publication No. 2002-203245, a rectangular area including a moving body is provided on a moving image and movement of the pixel value of the rectangle is tracked.

In the past, there were suggested numerous identifying methods of detecting a face of a person existing on a moving image and specifying who the person is. Specifically, there was suggested, for example, a method of extracting a feature amount of a detected face and verifying the feature amount in a database where pre-selected persons and the feature amounts of faces are registered in correspondence with each other to specify who a detected face is.

When the moving body tracking method and the face identification method described above are combined, for example, movement of a specific person appearing on moving-image contents can be tracked.

### SUMMARY OF THE INVENTION

In the above-described moving body tracking method, however, when a tracked object in an image is hidden in a shade or an image wholly becomes dark, the tracked object may be lost from view. In this case, the object has to be detected again for tracking. Therefore, the object may not be tracked continuously.

In the above-described face identification method, for example, a face looking straight forwards can be identified. However, a face, such as a laughing face or a crying face, with a facial expression may not be identified even for the same person. Moreover, a face, such as a side profile, looking in a direction other than the forward direction may not be identified.

The problems may arise even when the movement of a specific person appearing on an image of moving-image contents is tracked by combining the moving body tracking method and the face identification method.

It is desirable to provide a technique capable of continuously tracking the movement of a person appearing on an image of moving-image contents by specifying the face of the person.

According to an embodiment of the invention, there is provided an information processing apparatus which identifies persons appearing on moving-image contents with voices. The information processing apparatus includes: a detection unit detecting the faces of persons from frames of the moving-image contents; a first specifying unit specifying the persons corresponding to the detected faces by extracting feature amounts of the detected faces and verifying the extracted feature amounts in a first database in which the feature amounts of the faces are registered in correspondence with person identifying information; a voice analysis unit analyzing the voices acquired when the faces of the persons are detected from the frames of the moving-image contents and generating voice information; and a second specifying unit specifying the persons corresponding to the detected faces by verifying the voice information corresponding to the face of a person which is not specified by the first specifying unit among the faces detected from the frames of the moving-image contents in a second database in which the voice information is registered in correspondence with the person identifying information.

The information processing apparatus according to the embodiment of the invention may further include a registration unit registering the voice information corresponding to the faces of the persons specified by the first specifying unit among the faces detected from the frames of the moving-image contents in the second database in correspondence with the person identifying information on the specified persons.

The information processing apparatus according to the embodiment of the invention may further include a tracking unit tracking locations of the faces of the persons detected and specified on the frames of the moving-image contents.

The tracking unit may estimate a location of the face on the frame where the face of the person is not detected.

The tracking unit may estimate a location of the face based on a location locus of the face detected on at least one of previous and subsequent frames of the frame where the face of the person is not detected.

The tracking unit may estimate the location of the face based on continuity of the voice information corresponding to the face detected on an immediately previous frame of the frame where the face of the person is not detected and the voice information corresponding to the face detected on an immediately subsequent frame of the frame where the face of the person is not detected.

The voice analysis unit may extract a voice v1 of a face detection period in which the face of the person is detected from the frames of the moving-image contents and a voice v2 of a period in which the mouth of the detected person moves during the face detection period and may generate, as the voice information, a frequency distribution obtained through Fourier transform of a difference V between the voice v1 and the voice v2.

According to an embodiment of the invention, there is provided an information processing method of an information processing apparatus which identifies persons appearing on moving-image contents with voices. The information processing method causes the information processing apparatus to perform the steps of: detecting the faces of persons from frames of the moving-image contents; firstly specifying the persons corresponding to the detected faces by extracting feature amounts of the detected faces and verifying the extracted feature amounts in a first database in which the feature amounts of the faces are registered in correspondence with person identifying information; analyzing the voices acquired when the faces of the persons are detected from the frames of the moving-image contents and generating voice information; and secondly specifying the persons corresponding to the detected faces by verifying the voice information corresponding to the face of a person which is not specified in the step of firstly specifying the persons among the faces detected from the frames of the moving-image contents in a second database in which the voice information is registered in correspondence with the person identifying information.

According to an embodiment of the invention, there is provided a program controlling an information processing apparatus which identifies persons appearing on moving-image contents with voices. The program causes a computer of the information processing apparatus to execute the steps of: detecting the faces of persons from frames of the moving-image contents; firstly specifying the persons corresponding to the detected faces by extracting feature amounts of the detected faces and verifying the extracted feature amounts in a first database in which the feature amounts of the faces are registered in correspondence with person identifying information; analyzing the voices acquired when the faces of the persons are detected from the frames of the moving-image contents and generating voice information; and secondly specifying the persons corresponding to the detected faces by verifying the voice information corresponding to the face of a person which is not specified in the step of firstly specifying the persons among the faces detected from the frames of the moving-image contents in a second database in which the voice information is registered in correspondence with the person identifying information.

According to an embodiment of the invention, faces of persons are detected from frames of moving-image contents, feature amounts of the detected faces are extracted, and the persons corresponding to the detected faces are specified by executing verification in a first database in which the feature amounts of the faces are registered in correspondence with person identifying information. Voices acquired when the faces of the persons are detected from the frames of the moving-image contents are analyzed to generate voice information, and the persons corresponding to the detected faces are specified by verifying the voice information corresponding to the face of a person which is not specified among the faces detected from the frames of the moving-image contents in a second database in which the voice information is registered in correspondence with person identifying information.

According to the embodiments of the invention, it is possible to specify a person with a face appearing on an image of moving-image contents.

### BRIEF DESCRIPTION OF THE DRAWINGS

FIG. 1 is a block diagram illustrating an exemplary configuration of a person tracking device according to an embodiment of the invention.

FIG. 2 is a flowchart illustrating a person tracking process.

FIG. 3 is a flowchart illustrating a voice information registration process.

FIG. 4 is a diagram illustrating an example of a person-voice database.

FIG. 5 is a diagram illustrating face identification based on voice information.

FIG. 6 is a diagram illustrating a process of estimating the location of a person based on continuity of the voice information.

FIG. 7 is a diagram illustrating a process of determining whether discontinuity of a scene exists based on the continuity of the voice information.

FIG. 8 is a block diagram illustrating an exemplary configuration of a computer.

### DESCRIPTION OF THE PREFERRED EMBODIMENTS

Hereinafter, a preferred embodiment (hereinafter, referred to as an embodiment) of the invention will be described in detail with reference to the drawings. The description will be made in the following order.

### 1. Embodiment

### Exemplary Configuration of Person Tracking Device Operation of Person Tracking Device

### 1. Embodiment

### Exemplary Configuration of Person Tracking Device

A person tracking device according to an embodiment of the invention is a device that detects the face of a person from an image of moving-image contents with a voice, identifies the person, and continues to track the person.

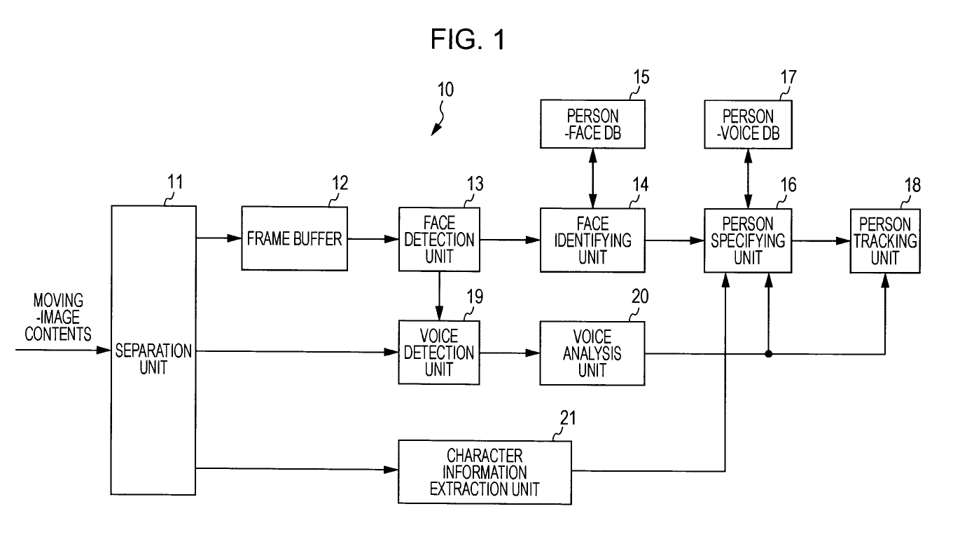

FIG. 1 is a diagram illustrating an exemplary configuration of the person tracking device according to the embodiment of the invention. A person tracking device 10 includes a separation unit 11, a frame buffer 12, a face detection unit 13, a face identifying unit 14, a person-face database (DB) 15, a person specifying unit 16, a person-voice database 17, a person tracking unit 18, a voice detection unit 19, a voice analysis unit 20, and a character information extraction unit 21.

The separation unit 11 separates moving-image contents (image, voice, and character information such as metadata or subtitles) input into the person tracking device 10 into image, voice, and character information. The separated image is supplied to the frame buffer 12, the voice is supplied to the voice detection unit 19, and the character information is supplied to the character information detection unit 21.

The frame buffer 12 temporarily stores the image of the moving-image contents supplied from the separation unit 11 frame by frame. The face detection unit 13 sequentially acquires the frames of the image from the frame buffer 12, detects the face of a person existing on the acquired frames, and outputs the acquired frames and the detection result to the face identifying unit 14. The face detection unit 13 detects a period in which a face is detected and a period in which the mouth of the face moves (utters) and notifies the voice detection unit 19 of the detection result.

The face identifying unit 14 specifies (identifies who the detected face is) a person with the detected face by calculating a feature amount of the face detected on the frames and verifying the calculated feature amount of the face in the person-face database 15. There may be a face which the face identifying unit 14 may not identify.

The person-face database 15 is prepared in advance by machine learning. For example, the feature amounts of faces are registered in correspondence with person identification information (names or the like) such as entertainers, athletes, politicians, and cultural figures appearing in the moving-image contents such as a television program or a movie.

The person specifying unit 16 allows voice information (which is supplied from the voice analysis unit 20) acquired upon detecting a face to correspond to the person with the face detected by the face detection unit 13 and identified by the face identifying unit 14, and registers the voice information in the person-voice database 17. Moreover, the person specifying unit 16 also allows keywords extracted by the character information extraction unit 21 to correspond to the person with the face identified by the face identifying unit 14 and registers the keywords in the person-voice database 17.

The person specifying unit 16 specifies a person with the detected face by verifying the voice information (which is supplied from the voice analysis unit 20), which is acquired upon detecting the face, on the face of a person which is not specified by the face identifying unit 14 among the faces detected by the face detection unit 13 in the person-voice database 17.

The person-voice database 17 registers the voice information in correspondence with the person identification information of the person specified for the detected face under the control of the person specifying unit 16. The registered details of the person-voice database 17 may be registered under the control of the person specifying 16 or may be registered in advance. Alternatively, the registered details from the outside may be added and updated. In addition, the registered details of the person-voice database 17 may be supplied to another person tracking device 10 or the like.

The person tracking unit 18 tracks the movement of the face of the person detected and specified in each frame. The person tracking unit 18 interpolates the tracking of the face for the frame, where the face of the person is not detected, by estimating the location of the undetected face based on the location of the face detected in the previous and subsequent frames thereof and the continuity of the voice information.

The voice detection unit 19 extracts a voice v1 of a face detection period in which the face detection unit 13 detects the face from the voice of the moving-image contents supplied from the separation unit 11. The voice detection unit 19 extracts a voice v2 of a period in which the mouth of the face moves during the face detection period. The voice detection unit 19 calculates a difference V between the voice v1 and the voice v2 and outputs the difference V to the voice analysis unit 20.

Here, it is assumed that the voice v1 does not include a voice uttered from the face-detected person and includes only an environmental sound. However, it is assumed that the voice v2 includes both the voice uttered from the face-detected person and the environmental sound. Therefore, the difference V is considered to include only the voice uttered by the face-detected person since the environmental sound is excluded.

The voice analysis unit 20 executes Fourier transform on the difference V (=v2−v1) input from the voice detection unit 19 and outputs a frequency distribution f of the difference V (voice uttered by the face-detected person) obtained through the Fourier transform as voice information to the person specifying unit 16. Moreover, the voice analysis unit 20 may detect change patterns of intonation, intensity, accent, and the like of the uttered voice (difference V) as well as the frequency distribution f, and may permit the change patterns to be included in the voice information so as to be registered.

The character information extraction unit 21 analyzes the morphemes of character information (overview description sentences, subtitles, telop, and the like of the moving-image contents) of the moving-image contents supplied from the separation unit 11, and extracts proper nouns from the result. Since it is considered that the proper nouns include the name, a role name, a stereotyped phase, and the like of the face-detected person, the name, the role name, the stereotyped phase, and the like of the face-detected person are supplied as keywords to the person specifying unit 16.

### Operation of Person Tracking Device

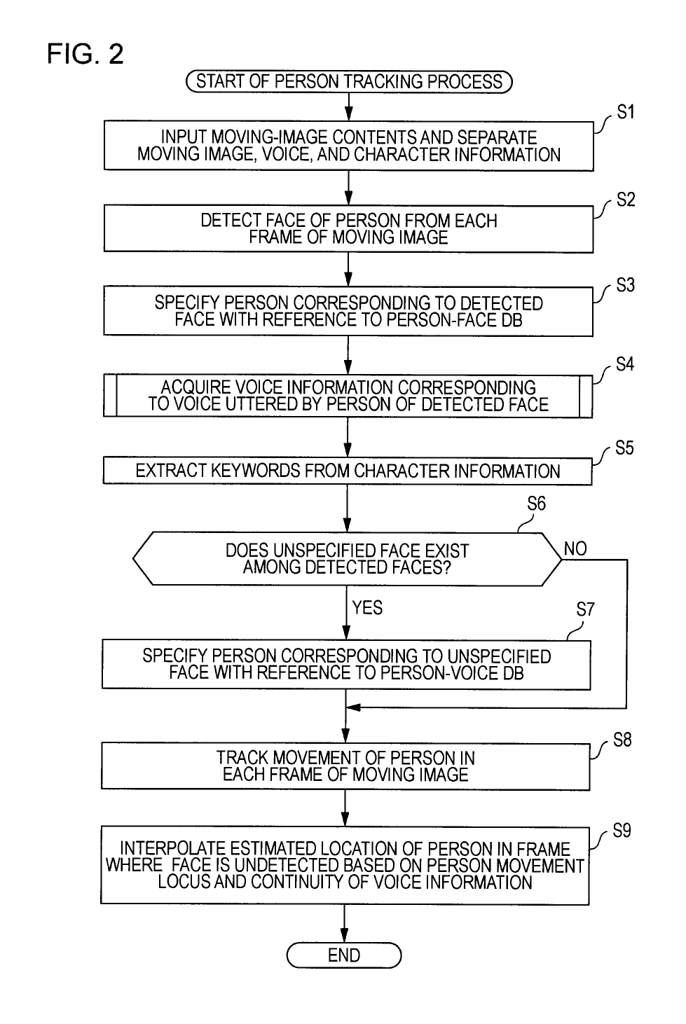

Next, the operation of the person tracking device 10 will be described. FIG. 2 is a flowchart illustrating a person tracking process of the person tracking device 10.

The person tracking process is a process of detecting the face of a person from an image of moving-image contents with a voice, identifying the person, and continuously tracking the person.

In step S1, the moving-image contents are input to the person tracking device 10. The separation unit 11 separates images, voices, and character information of the moving-image contents and supplies the images, the voices, and the character information to the frame buffer 12, the voice detection unit 19, and the character information detection unit 21, respectively.

In step S2, the face detection unit 13 sequentially acquires the frames of the images from the frame buffer 12, detects the faces of persons existing on the acquired frames, and outputs the detection result and the acquired frames to the face identifying unit 14. Here, faces with various facial expressions and faces looking in various directions are detected as well as faces looking straight forwards. An arbitrary existing face detection technique may be used in the process of step S2. The face detection unit 13 detects the face detection period and the period in which the mouth of the person moves and notifies the voice detection unit 19 of the detection result.

In step S3, the face identifying unit 14 specifies the persons with the detected faces by calculating the feature amounts of the faces detected on the frames and verifying the calculated features amounts in the person-face database 15.

On the other hand, in step S4, the voice detection unit 19 extracts voices corresponding to the voices uttered by the face-detected persons from the voices of the moving-image contents, the voice analysis unit 20 acquires the voice information corresponding to the extracted voices, and the person specifying unit 16 registers the voice information in the person-voice database 17 in correspondence with the identified persons. For example, as shown in FIG. 4, the voice information (frequency distribution f) is generated in the person-voice database 17 in correspondence with person identifying information (the name of Person A or the like).

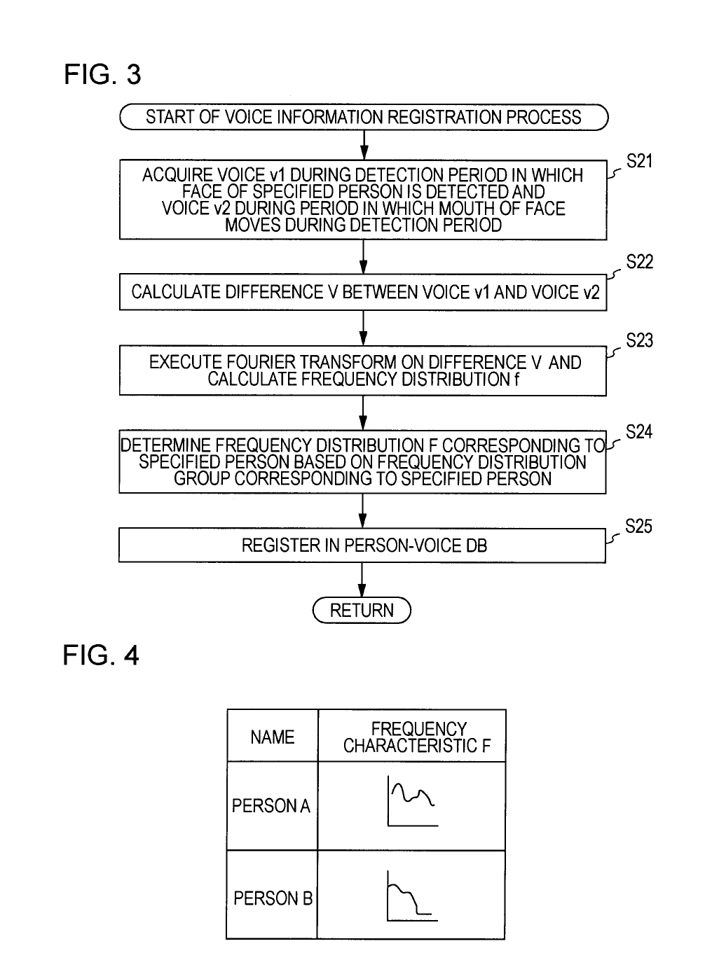

A process (hereinafter, referred to as a voice information registration process) of step S4 will be described in detail. FIG. 3 is a flowchart illustrating the voice information registration process.

In step S21, the voice detection unit 19 extracts the voice v1 of the face detection period in which the face detection unit 13 detects the face from the voice of the moving-image contents supplied from the separation unit 11. The voice detection unit 19 extracts the voice v2 of the period in which the mouth of the face moves during the face detection period. In step S22, the voice detection unit 19 calculates the difference V between the voice v1 and the voice v2 and outputs the difference V to the voice analysis unit 20.

In step S23, the voice analysis unit 20 executes Fourier transform of the difference V (=v2−v1) input from the voice detection unit 19 and outputs the frequency distribution f of the difference V (voice uttered by the person of the detected face) obtained through the Fourier transform as the voice information to the person specifying unit 16.

It is not appropriate to register the frequency distribution f corresponding to a one-time uttered voice as the voice information to identify the person. Therefore, in step S24, the person specifying unit 16 groups the frequency distribution f of the corresponding uttered voice (difference V) when a face identified with the same person is detected, into frequency distribution groups and determines the frequency distribution f by averaging the frequency distribution groups. In step S25, the person specifying unit 16 registers the frequency distribution f as the voice information of the corresponding person in the person-voice database 15.

In step S5, referring to FIG. 2 again, the character information extraction unit 21 extracts the proper nouns by analyzing the morphemes of the character information of the moving-image contents supplied from the separation unit 11, and supplies the proper nouns as keywords to the person specifying unit 16. The person specifying unit 16 registers the input keywords in the person-voice database 17 in correspondence with the identified persons.

In step S6, the person specifying unit 16 determines whether the face of a person which is not specified by the face identifying unit 14 exists among the faces detected by the face detection unit 13. When it is determined that the face exists, the process proceeds to step S7. In step S7, the person specifying unit 16 specifies the person with the detected face by verifying the voice information (which is supplied from the voice analysis unit 20), which is acquired upon detecting the face, on the face of a person which is not specified among the faces detected in the face detection unit 13 in the person-voice database 17.

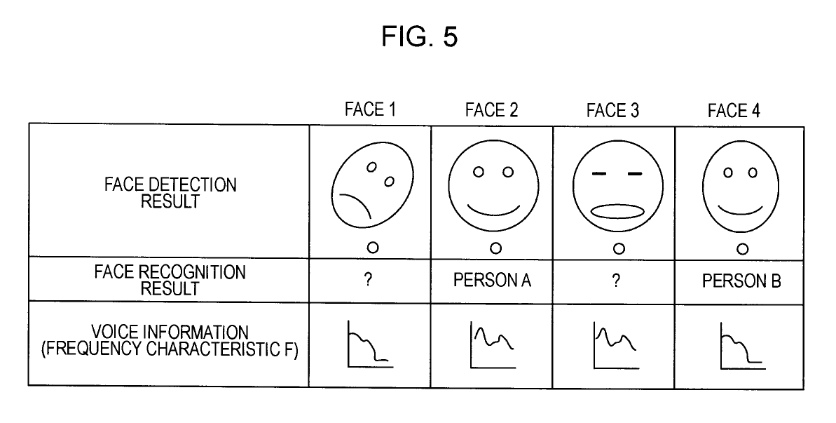

Hereinafter, the processes of steps S6 and S7 will be described with reference to FIG. 5.

For example, when the face detection unit 13 detects Face 2 shown in FIG. 5 in step S2, the face identifying unit 14 identifies Person A based on the feature amount of the face in step S3. Similarly, when the face detection unit 13 detects Face 4 shown in FIG. 5 in step S2, the face identifying unit 14 identifies Person B based on the feature amount of the face in step S3.

However, when the face detection unit 13 detects Face 1 shown in FIG. 5 in step S2, the person may not be identified due to the expression or the direction of the face in step S3. In this case, the voice information corresponding to Face 1 is verified in the person-voice database 17 in step S7. Then, when the voice information corresponding to Face 1 is similar to the voice information of Person B, the person with Face 1 is identified as Person B.

Similarly, when the face detection unit 13 detects Face 3 shown in FIG. 5 in step S2, the person may not be identified due to the expression or the direction of the face in step S3. In this case, the voice information corresponding to Face 3 is verified in the person-voice database 17 in step S7. Then, when the voice information corresponding to Face 3 is similar to the voice information of Person A, the person with Face 3 is identified as Person A.

Of course, in order to identify the person with detected Face 1 as Person B, the voice information of Person B has to be registered in advance in the person-voice database 17, or the voice information acquired upon identifying and detecting the face detected on the frame as Person B has to be registered in the person-voice database 17 in correspondence with the person identification information of Person B until the identification is performed. Similarly, in order to identify the person with detected Face 3 as Person A, the voice information of Person A has to be registered in advance in the person-voice database 17, or the voice information acquired upon identifying and detecting the face detected on the frame as Person A has to be registered in the person-voice database 17 in correspondence with the person identification information of Person A until the identification is performed.

In step S6, when it is determined that the face of a person which is not specified by the face identifying unit 14 does not exist among the faces detected by the face detection unit 13 with reference to FIG. 2 again, step S7 skips and the process proceeds to step S8.

In step S8, the person tracking unit 18 tracks the movement of the face of the person detected on each frame in step S2 and specified in step S3 or S7. Moreover, not only the face but also the recognized parts of the face may be tracked.

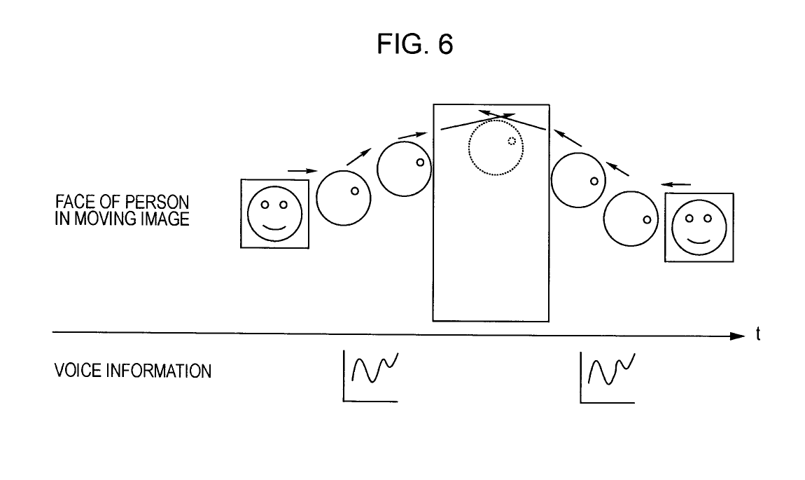

In step S9, when the frame where the face of the person is not detected in step S2 exists, the person tracking unit 18 determines whether the voice information corresponding to the immediately previous frame of the corresponding frame is similar to the voice information corresponding to the immediately subsequent frame of the corresponding frame. When it is determined that both the frames are similar to each other, as shown in FIG. 6, the locus (locus of a forward direction) of the face detected and tracked up to the corresponding frame and the locus (locus of a backward direction) of the face detected and tracked after the corresponding frame each extend, and the location where the loci intersect each other on the corresponding frame is estimated as the location where the face exists.

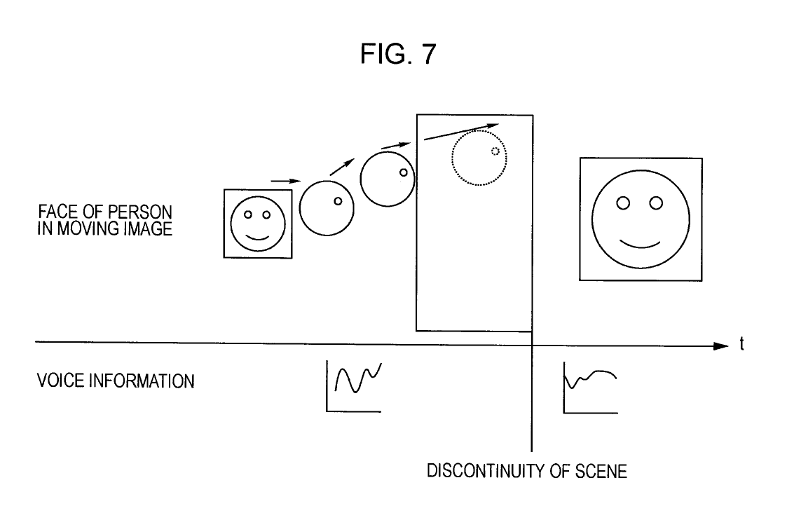

As shown in FIG. 7, when it is determined that the voice information corresponding to the previous frame of the corresponding frame is not similar to the voice information corresponding to the subsequent frame of the corresponding frame, it is determined that a discontinuity (scene change) of scenes in the boundary of the corresponding frame exists. In this case, the location where the locus (locus of the forward direction) of the face detected and tracked up to the corresponding frame extends on the frame is estimated as the location where the face exists. Then, the person tracking process ends.

When the above-described person tracking process is used, a specific person can be tracked in a moving image. Moreover, even when the specific person hides in the shade on an image, the location of the specific person can be tracked.

That is, the location of the specific person can be typically confirmed on the image using the person tracking process. For example, the person tracking process is applicable to an application in which information regarding a person is displayed when the person appearing on an image of moving-image contents is clicked with a cursor.

The above-described series of processes may be executed by hardware or software. When the series of processes are executed by software, a program of the software is installed from a program recordable medium on a computer embedded with a dedicated hardware or a computer such as a general personal computer capable of executing various functions by installing various programs.

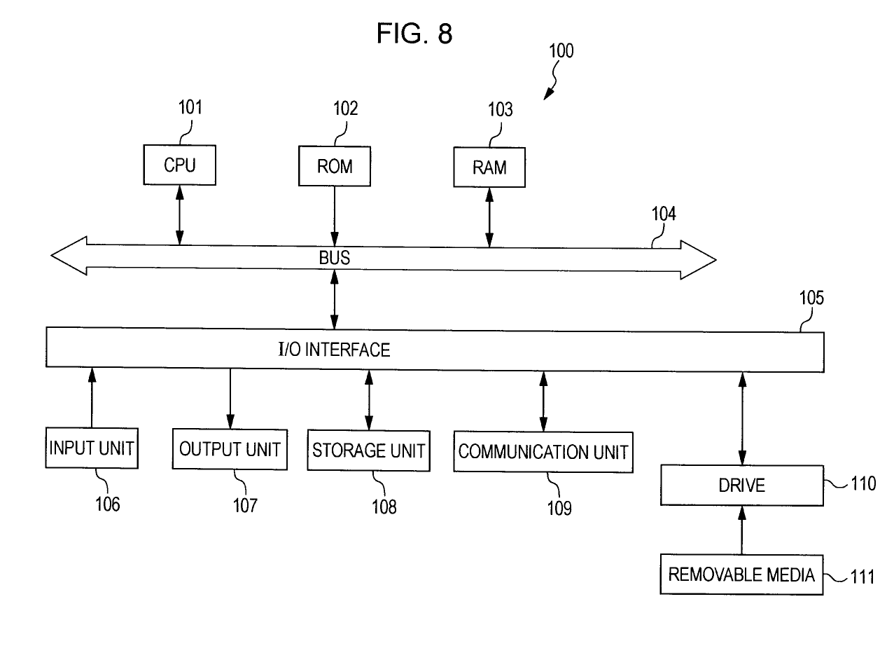

FIG. 8 is a block diagram illustrating an exemplary hardware configuration of a computer executing the above-described series of processes according to a program.

In a computer 100, a CPU (Central Processing Unit) 101, a ROM (Read-Only Memory) 102, and a RAM (Random Access Memory) 103 are connected to each other through a bus 104.

An I/O interface 105 is also connected to the bus 104. An input unit 106 having a keyboard, a mouse, a microphone, or the like, an output unit 107 formed by a display, a speaker, or the like, a storage unit 108 formed by a hard disk, a non-volatile memory, or the like, a communication unit 109 formed by a network interface or the like, and a drive 110 driving a removable media 111 such as a magnetic disk, an optical disk, a magnetooptical disk, or a semiconductor memory are connected to the I/O interface 105.

In the computer 100 with the above configuration, for example, the CPU 101 loads and executes a program stored in the storage unit 108 on the RAM 103 via the I/O interface 105 and the bus 104 to process the above-described series of processes.

The program executed by the computer may be a program executing the processes chronologically in the order described in the specification or a program executing the processes in parallel or at a timing at which the program is called.

The program may be executed by one computer or by a plurality of computers in a distributed process. The program may be transmitted to a computer located elsewhere for execution.

The present application contains subject matter related to that disclosed in Japanese Priority Patent Application JP 2009-278180 filed in the Japan Patent Office on Dec. 8, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus which identifies persons appearing on moving-image contents with voices, comprising:
a detection unit detecting the faces of persons from frames of the moving-image contents;
a first specifying unit specifying the persons corresponding to the detected faces by extracting feature amounts of the detected faces and verifying the extracted feature amounts in a first database in which the feature amounts of the faces are registered in correspondence with person identifying information;
a voice analysis unit analyzing the voices acquired when the faces of the persons are detected from the frames of the moving-image contents and generating voice information; and
a second specifying unit specifying the persons corresponding to the detected faces by verifying the voice information corresponding to the face of a person which is not specified by the first specifying unit among the faces detected from the frames of the moving-image contents in a second database in which the voice information is registered in correspondence with the person identifying information.

2. The information processing apparatus according to claim 1, further comprising:
a registration unit registering the voice information corresponding to the faces of the persons specified by the first specifying unit among the faces detected from the frames of the moving-image contents in the second database in correspondence with the person identifying information on the specified persons.

3. The information processing apparatus according to claim 1 or 2, further comprising:
a tracking unit tracking locations of the faces of the persons detected and specified on the frames of the moving-image contents.

4. The information processing apparatus according to claim 3, wherein the tracking unit estimates a location of the face on the frame where the face of the person is not detected.

5. The information processing apparatus according to claim 4, wherein the tracking unit estimates a location of the face based on a location locus of the face detected on at least one of previous and subsequent frames of the frame where the face of the person is not detected.

6. The information processing apparatus according to claim 5, wherein the tracking unit estimates the location of the face based on continuity of the voice information corresponding to the face detected on an immediately previous frame of the frame where the face of the person is not detected and the voice information corresponding to the face detected on an immediately subsequent frame of the frame where the face of the person is not detected.

7. The information processing apparatus according to claim 1, wherein the voice analysis unit extracts a voice v1 of a face detection period in which the face of the person is detected from the frames of the moving-image contents and a voice v2 of a period in which the mouth of the detected person moves during the face detection period and generates, as the voice information, a frequency distribution obtained through Fourier transform of a difference V between the voice v1 and the voice v2.

8. An information processing method of an information processing apparatus which identifies persons appearing on moving-image contents with voices, the information processing method causing the information processing apparatus to perform the steps of:
detecting the faces of persons from frames of the moving-image contents;
firstly specifying the persons corresponding to the detected faces by extracting feature amounts of the detected faces and verifying the extracted feature amounts in a first database in which the feature amounts of the faces are registered in correspondence with person identifying information;
analyzing the voices acquired when the faces of the persons are detected from the frames of the moving-image contents and generating voice information; and
secondly specifying the persons corresponding to the detected faces by verifying the voice information corresponding to the face of a person which is not specified in the step of firstly specifying the persons among the faces detected from the frames of the moving-image contents in a second database in which the voice information is registered in correspondence with the person identifying information.

9. A program controlling an information processing apparatus which identifies persons appearing on moving-image contents with voices, the program causing a computer of the information processing apparatus to execute the steps of:
detecting the faces of persons from frames of the moving-image contents;
firstly specifying the persons corresponding to the detected faces by extracting feature amounts of the detected faces and verifying the extracted feature amounts in a first database in which the feature amounts of the faces are registered in correspondence with person identifying information;
analyzing the voices acquired when the faces of the persons are detected from the frames of the moving-image contents and generating voice information; and
secondly specifying the persons corresponding to the detected faces by verifying the voice information corresponding to the face of a person which is not specified in the step of firstly specifying the persons among the faces detected from the frames of the moving-image contents in a second database in which the voice information is registered in correspondence with the person identifying information.
